(19) United States
(12) Patent Application Publication
(10) Pub. No.: US 2007/0246148 A1
(43) Pub. Date: Oct. 25, 2007

(54) Method of making mosaic tiles and tiles made thereby

(76) Inventor: Daniel Adrian Barnes, Plymouth, IA (US)

Correspondence Address: BARBER LEGAL, P.O. BOX 16220, GOLDEN, CO, 80402-6004, US

(21) Appl. No.: 11/407,563

(22) Filed: Apr. 19, 2006

(51) Int. Cl. C03B 29/00; B44C 1/165; B44C 1/175; B28B 1/00

(52) U.S. Cl. 156/89.11; 156/230; 156/277; 156/237; 264/680

(57) ABSTRACT

An improved method of making a ceramic tile mural or mosaic comprises printing out an image from a digital device using special high fire ceramic toners onto decal paper, printing out the decals in sizes permitting multiple tiles to be covered by a single decal. After transfer, the decal is cut along tile edges and the tiles high fired. After high firing, ceramic luster is applied to the tiles and the tiles are low fired. A mural/mosaic made by the method of the invention is also taught.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to digital methods of making ceramic murals and mosaics, and specifically to improved methods allowing multiple tile printing and high luster tiles.

### STATEMENT REGARDING FEDERALLY FUNDED RESEARCH

This invention was not made under contract with an agency of the US Government, nor by any agency of the US Government.

### BACKGROUND OF THE INVENTION

Making of murals from a plurality of ceramic tiles may be a difficult and/or time consuming task requiring hand labor for the making of murals which have actual pictorial elements. Most ceramic tile murals tend to have simple designs (one or two types of tiles varied in a simple geometric pattern) and low luster.

It will be understood that even a simple mural (the term mosaic may be used interchangeably in this application) generally has a gloss colored glaze, with no luster overglaze added. Such murals may be made, for example, by taking two colors of tiles (such as black and white) and placing the tiles in geometric shapes. Ignoring the low luster problem, for any reasonable number of “pixels” such designs do not allow true pictorial artwork. For example, a mural of 1 inch tiles (2.54 cm) of either black or white, if made 6 feet by 4 feet in size (˜183 cm×122 cm) will have only 72 tiles by 48 tiles for a total of 3456 tiles. This would be a mural of roughly 1.1% of the size and resolution of a “VGA” quality image, in black and white only, and VGA quality is generally considered to be somewhat poor for image representation even in full color. Yet laying 3,456 tiles by hand to create a 6 by 4 foot image is considered a fairly large piece of tile work.

Since making murals having more numerous tiles quickly becomes impracticable for anything but simple designs (where groups of tiles having very simple patterns thereon may be laid), the only solution allowing creation of genuine pictorial murals is the creation of larger tiles which individually have a section of a picture thereon.

This incurs new penalties and problems. Each tile must have color patterns, particularly on the edges, which match to the tiles surrounding to create the overall image. Painting glaze onto each tile by hand can be done at enormous labor and expense, but simpler and cheaper methods would be desirable.

One known method is via silk screening of designs onto tiles, however, this process is extremely expensive to set up, requiring either enormous expense for each process or else requiring a large “run” of many identical murals, rather than custom murals.

Another known alternative which allows digital devices to print out images for tiles is the dye-sublimation process. This works quickly and well and does not even require a true “high temperature firing” (high temperature baking of the ceramics), however for technical reasons the maximum size of an individual print is 25.5 inches. Worse, tiles made using dye-sublimation suffer from being extremely easy to scratch, not stable under UV exposure, and the design wears off quite quickly, since it is not truly “high fired” into the ceramic like a true glaze or overglaze.

Firing production of individual tiles for mural use is known, including use of hand brushwork and decals having partial images printed thereon for actual firing. An example of this may be seen at www.armenianceramics.com however this still remains a laborious process which does not appear to address the need for multiple tile printed decals and the need to eliminate brushwork, nor the need for a high luster.

Significantly, a corporation in the United Kingdom, Digital Ceramic Systems, has within the last few years produced toners which may be printed out to create decals. The decals may be transferred onto ceramics such as mugs, plates, pots and the like and high fired to produce a mug or whatnot with the desired image (for example of a family photograph) on the mug in durable form, a form much more durable than conventional dye sublimation techniques.

### SUMMARY OF THE INVENTION

General Summary

The present invention teaches that multiple tile ceramic murals or mosaics may be made by a method allowing high production rates by coloring multiple tiles with a single printed decal, and high luster by means of ceramic luster. The tiles of the invention are durable, as the coloring is not applied using known digital/computerized methods which involve dye sublimation or laborious hand painting. The tiles of the invention are high luster due to application of ceramic luster by efficient spray methods.

The method of the invention comprises printing out an edited image from a digital device/computer using special high fire ceramic toners of recent development onto large sizes of decal paper and printing out the decals in sizes permitting multiple tiles to be covered by a single decal. After transfer of the decal from the backing material to the tile, the decal is cut along tile edges and the tiles are high fired. After the high firing, ceramic luster is applied to the tiles and the tiles are low fired.

A mural/mosaic made by the method of the invention is also taught.

Summary in Reference to Claims

It is therefore a first aspect, advantage, objective and embodiment of the invention to provide a method of making a tile mural comprising the steps of:
a) scanning a desired image into a digital device;
b) providing a color printer in operative communication with the digital device, the color printer having ceramic decal print colors and ceramic decal paper for printing onto;
c) directing the color printer to print a first portion of the image onto the ceramic decal paper in multi-tile size using the ceramic decal print colors;
d) laminating the printed sheets;
e) providing multiple blank ceramic tiles having edges;
f) clamping the multiple blank ceramic tiles into a frame;
g) transferring the decal to the multiple ceramic tiles;
h) cutting the decal along the ceramic tile edges;
i) drying the tiles;
j) high firing the tiles;
k) applying ceramic luster to the tiles; and
l) low firing the tiles.

It is therefore another aspect, advantage, objective and embodiment of the invention to provide a method of making a tile mural, further comprising:
m) repeating steps c) through l) for a second portion of the image.

It is therefore another aspect, advantage, objective and embodiment of the invention to provide a method of making a tile mural, further comprising:
j1) cooling the tiles after high firing.

It is therefore another aspect, advantage, objective and embodiment of the invention to provide a method of making a tile mural, further comprising:
l1) cooling the tiles after low firing.

It is therefore another aspect, advantage, objective and embodiment of the invention to provide a method of making a tile mural, wherein the step k) further comprises:

applying the luster by spray.

It is therefore another aspect, advantage, objective and embodiment of the invention to provide a method of making a tile mural, wherein the step g) further comprises:

soaking the decal to loosen the decal from the backing material prior to transfer.

It is therefore another aspect, advantage, objective and embodiment of the invention to provide a method of making a tile mural, further comprising:
g1) squeezing excess air and water from under the decal after transfer.

It is therefore another aspect, advantage, objective and embodiment of the invention to provide a method of making a tile mural, wherein the high firing further comprises: high firing the tiles to cone 015.

It is therefore another aspect, advantage, objective and embodiment of the invention to provide a method of making a tile mural, wherein the firing further comprises: firing the tiles to cone 020.

It is therefore another aspect, advantage, objective and embodiment of the invention to provide a method of making a tile mural, further comprising:
a1) editing the image in the digital device.

It is therefore another aspect, advantage, objective and embodiment of the invention to provide a mural made by the method of the first paragraph of this section.

It is therefore another aspect, advantage, objective and embodiment of the invention to provide an improved method of creating a mural, wherein the improvement comprises:
a) printing onto multiple tile sized paper a decal using toners suitable for high firing; and
b) after high firing, spraying on ceramic luster and low firing.

### BRIEF DESCRIPTION OF THE DRAWINGS

FIG. 1 is a planform view of a mural made by means of a first embodiment of the method of the invention, showing making of a relatively small mural.

FIG. 2 is a cross-sectional view of a second embodiment of an exemplary tile in the process of being made by means of the method of the invention.

FIG. 3 is a planform view of a mural made by means of a third embodiment of the invention, showing a larger mural made by means of the method of the invention.

FIG. 4A is a partial flowchart of the steps of the preferred fourth embodiment of the invention.

FIG. 4B is a partial flowchart of the steps of the preferred fourth embodiment of the invention.

FIG. 4C is a partial flowchart of the steps of the preferred fourth embodiment of the invention.

FIG. 4D is a partial flowchart of the steps of the preferred fourth embodiment of the invention.

FIG. 5 is a block diagram overview of the entire process of the invention.

FIG. 6 is a perspective view of an item of furniture incorporating an alternative preferred mural embodiment of the invention.

### INDEX TO REFERENCE NUMERALS

Mural/mosaic 100
First tile 101
Second tile 103
Exemplary tile row 201
Decal 203
Top surface of exemplary tile 205
Thin layer of air/water within and under exemplary tile 206
Mosaic/mural 300
First tile 301
Second tile 303
Area covered by a first decal sheet 311
Image entry 401
Image editing 403
Sending image to printer 405
Print image using high fire toner 407
Laminate printed sheets 409
Easel tiles 411
Soak and remove backing paper 413
Place sheet over multiple tiles 415
Squeegee air/water from tiles 417
Cut sheet along tile boundaries 419
Repeat steps 411-419 as necessary 421
Dry tiles 423
Prep and place in kiln 425
High fire tiles 427
Cool tiles 429
Spray luster 431
Prep and place in kiln 433
Second firing of tiles 435
Cool tiles 437
Buff tiles 439
Computer/digital device 525
Printer/copier with ceramic decal toners and paper 527
Ceramic decal with backing material 529
Decal at transfer to tiles 531
Multiple Ceramic tiles 533
Kiln 535
Spray luster 537
In-laid table 639
Mural/mosaic pattern 641

### DETAILED DESCRIPTION

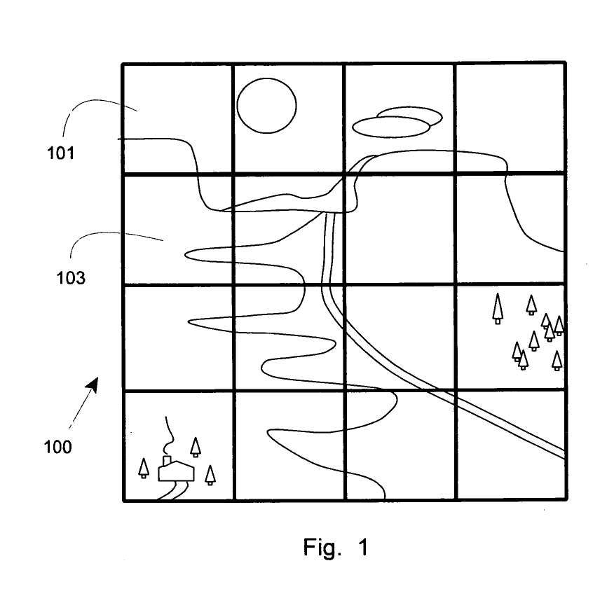

FIG. 1 is a planform view of a mural made by means of a first embodiment of the method of the invention, showing making of a relatively small mural.

Mural/mosaic 100 has an image which is composed of a number of smaller images, each on one tile such as first tile 101 and second tile 103. However, the tile edges must match to each other, and the tiles must be properly arranged, for the overall design to emerge. The ceramic tiles may be any of several types of ceramic materials: refractory materials, true ceramics, glass tiles, mirror coated glass tiles and so on.

In prior art computer/digital practice, it would be necessary to print out each tile individually, using conventional dye sublimation techniques. Such a mural would not wear well, as the heat transfer dye sublimation process does not lend itself to durable coloration. The present invention however, teaches that a plurality of the tiles may be treated by a single decal printing technique. Thus tile 101 and tile 103 might be covered by a single printed decal of larger size, or a larger multiple of tiles, potentially even the entire mosaic, might be covered by a single printed out decal sheet of sufficient size.

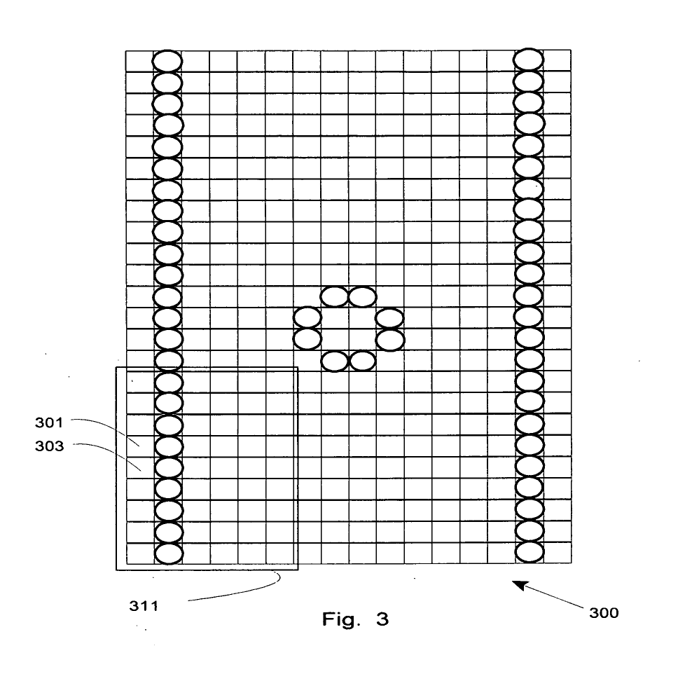

FIG. 3 is a planform view of a mural made by means of a third embodiment of the invention, showing a larger mural made by means of the method of the invention. Some murals have very simple designs, normally constructed in prior practice by creating numbers of tiles of a small number of types, then assembling them by hand to make geometric patterns. The present invention teaches that even such simple murals may be made more quickly and more easily. Tiles 301 and 303, as well as a large multiple number of tiles (54 total in the example, but any multiple number from 2 on up may be used) may be covered by a single sheet 311 of decal to make a simpler pattern. While such a pattern may be more easily assembled than the more complex image of FIG. 1, and while it may by conventional techniques be relatively simple to assemble, the present invention may nonetheless speed and easy the process of making mural 300.

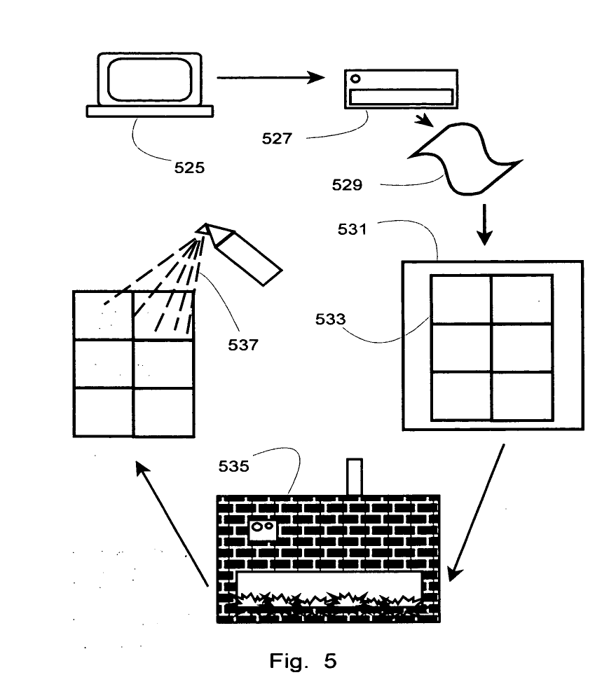

FIG. 5 is a block diagram overview of the entire process of the invention. An image is input via scanning or the like into computer/digital device 525 and may be edited therein and sent via RIP Fiery server or the like to printer 527 equipped with ceramic decal toners and paper. The image is then printed out to make ceramic decal with backing material 529. It is worth noting that in the presently preferred embodiment a number of different portions of a very large image may be printed out: one portion of the image covering a first multiplicity of tiles, a second portion of the image covering a second multiplicity of tiles and so on. For high gloss applications, a flux type laminate cover coat or a similar laminate cover of the same type may be applied to the decal.

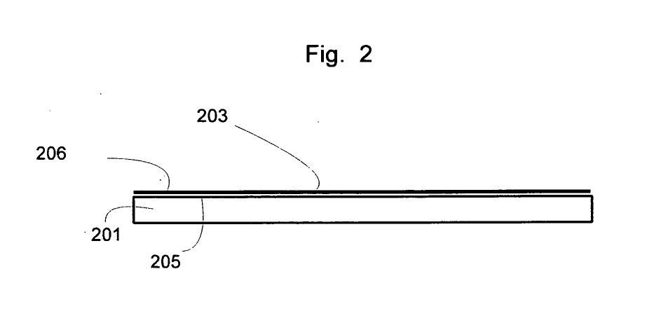

The backing material/substrate may be removed (by peeling, soaking, etc, depending upon the technology, at the present time soaking is used) leaving decal at transfer to tiles 531 covering one surface, usually the upper but potentially the lower surface in two sided embodiments, of multiple ceramic tiles 533. The decal may then be cut to fit the individual tiles, or the cutting to the tiles may occur before the soaking and transfer. The tiles may then be dried before firing. Water and air trapped under the decal may be removed by squeegee. FIG. 2 is a cross-sectional view of a second embodiment of an exemplary tile in the process of being made by means of the method of the invention. Application of the decal to the tiles occurs by soaking the backing material and removing it, and transfer of the actual decal itself to an upper surface of a multiplicity of tiles.

Exemplary tile row 201 may have decal 203 applied to the top surface 205. Normally, these may leave a very thin layer of air and or water 206 within and under the decal 203. This may be squeezed out by means of a squeegee or the like. Drying of the tiles prior to firing is necessary as ceramics may be discolored or damaged within a kiln, or on occasion may even explode, if water remains present as the temperatures rise.

Averting to FIG. 5, tiles 531 may then be placed into kiln 535, preferably in a frame containing a multiplicity of tiles. The tiles may be fired to cone 015, representing a temperature of 1472 degrees Fahrenheit, roughly 800 degrees Centigrade. After removal, the tiles may be cooled, and spray luster 537 may be applied. After luster has dried, the tiles may be low fired to cone 020 (1180 degrees Fahrenheit).

The resulting tiles may be removed from frames and sent out for assembly. The tiles may be labeled either on the back (for designs having no mirror finish on the back, non-glass tile designs, and for tiles not having murals on both sides), or in other cases by means of removable labels which may indicate the proper placement of tiles in the overall finished image.

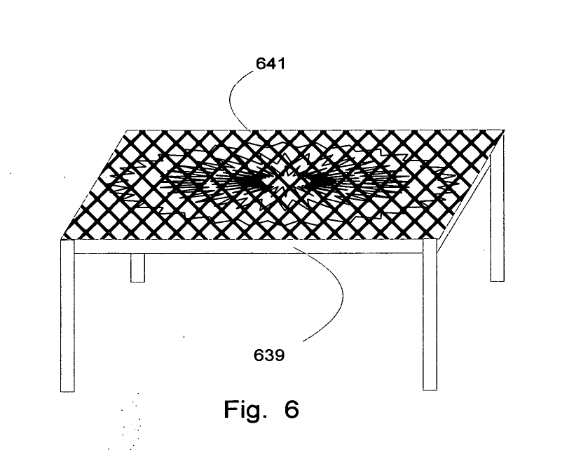

FIG. 6 is a perspective view of an item of furniture incorporating an alternative preferred mural embodiment of the invention. Table 639 has an in-laid table top having a pattern thereon, the individual tiles may be very distinctive and individual, yet printed out in multiple units for each individual item of furniture. Other items of furniture besides tables may be created, in particular counter tops for either kitchen or bathroom, as well as end tables, coffee tables, desks, credenzas, hutches, cases, cupboards and so on.

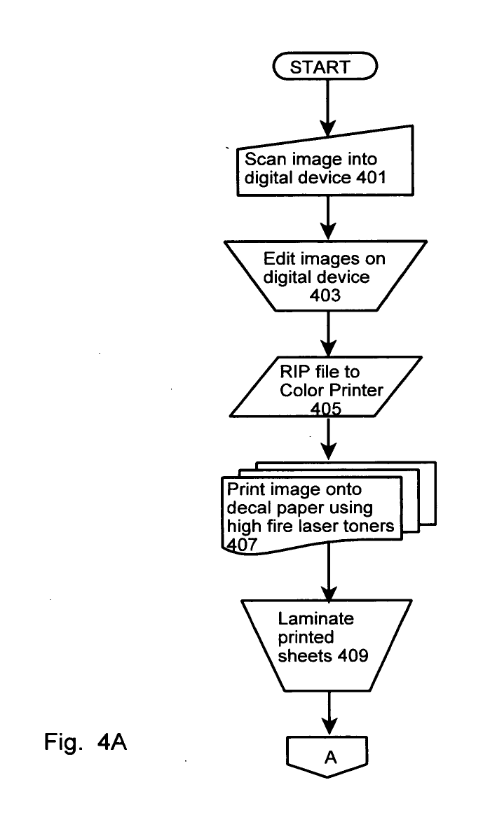

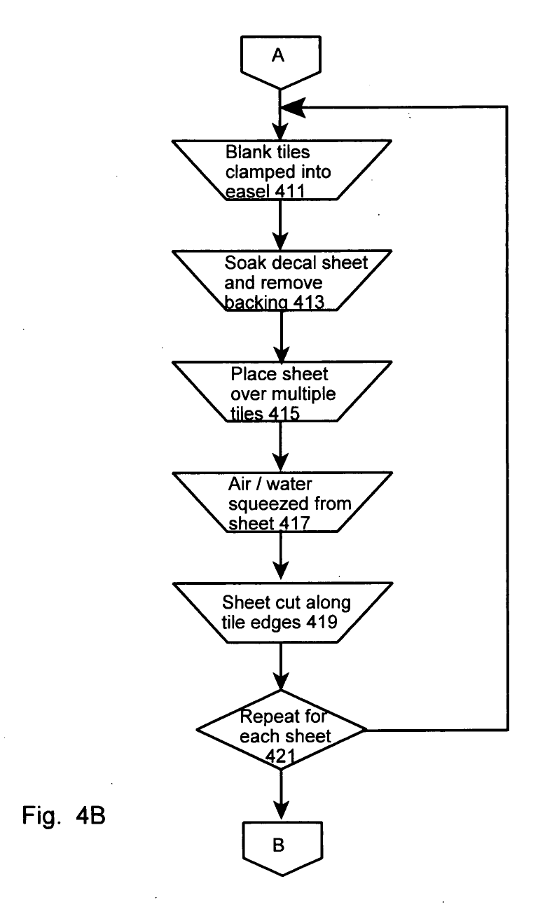

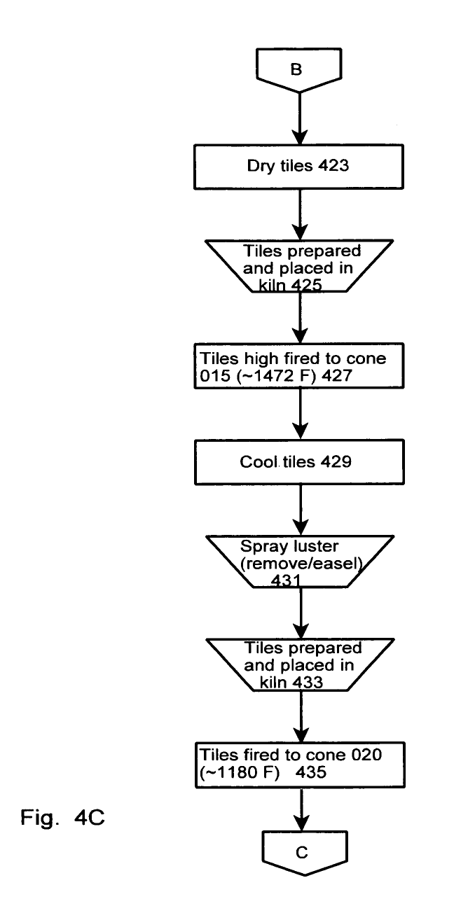

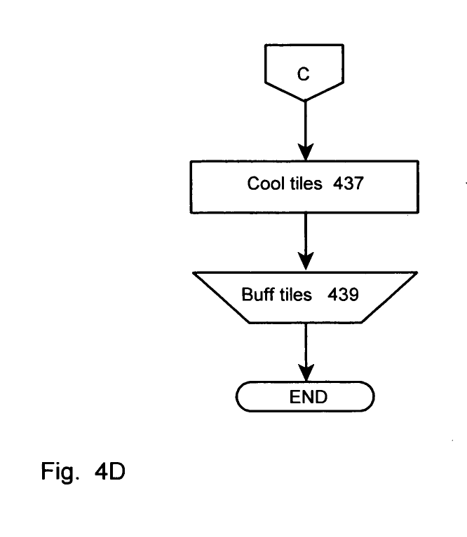

FIGS. 4A through 4D are a flowchart of the steps of the preferred fourth embodiment of the invention. In the presently preferred embodiment and best mode presently contemplated for carrying out the invention, a large number of process steps come together to allow creation of high luster, durable and low labor ceramic/glass murals and mosaics.

Image entry 401 is a first step: the image to be fired onto the mural must be entered into the digital device/computer by any conventional means now known or later developed. A number of mechanical carriers such as networks, diskettes, portable memory devices, scanning and the like may be used, as may numerous formats for images such as JPEG format and others too numerous to discuss. At the present time, personal computers are favored digital devices, though the invention is not so limited.

Image editing step 403 in the digital device is a necessary step to achieve maximum artistic satisfaction with the final mural, and in addition the editing allows selection of sizes of decals to be printed, selection of colorations and so on. Such editing has been tested using commercially available software such as Adobe Photoshop CS2, (trademark not associated with applicant) but other image editing software now known or later developed may be used instead.

Sending of the image to the printer 405 is a fairly easy step thanks to convenient printer languages and file formatting such as the raster imaging process (RIP), testing has revealed that a Canon (trademark not associated with applicant) RIP Fiery server provides excellent results.

Print image using high fire toner 407 is a crucial step. High fire toners are a recent invention, in fact at the present time the applicant knows of only one source of supply, the Digital Ceramic Systems organization in the United Kingdom, and it is believed that the toners themselves are the subject of UK patents. The toners allow printing onto a large decal, for example, onto A3 paper size, having a backing material/substrate and the actual decal formed thereon, which comprises the toners themselves.

Laminate printed sheets 409 allows application of a “high gloss” final finish to the finished mural. The tiles may then be clamped into a large easel (step 411).

Soaking and removal of backing paper 413 allows transfer of the decal itself to the multiple tiles. Placement of the sheet over multiple tiles 415 is a step which is very important to the present invention in allowing a dramatic decrease in labor over prior art systems while still allowing creation of a design more durable than mere dye sublimation can produce.

Squeegeeing air/water from tiles 417 adheres the colors tightly against the glaze and aids the drying of the tiles (step 423) via air drying or the like. Such drying is necessary, whether by air alone, forced air, squeegeeing and the like.

Cutting sheets along tile boundaries 419 is much easier than printing of individual tiles or the like. These steps may then be repeated (421) in whole or in part as necessary to cover the entire mural and/or print out the entire image.

The tiles are then prepared for firing and placed into a kiln 425 for high firing (step 427). Time and temperatures may be varied within the scope of the invention, however, high firing is considered a much better process than heat transfer. Dye sublimation methods, for example, use heat transfer. Heat transfer overglazes/colorations tend to be much less durable than high firing, but dye sublimation methods do not allow high firing as they cannot withstand high firing. Prior to the invention of high fire decal printing for mugs or the like this was unknown. (Dye sublimation temperatures tend to be very low in comparison to actual ceramic firing, i.e. 200 degrees Centigrade versus 800 degrees Centigrade which dramatic spread in temperature is explained by the fact that dye sublimation is an ink, not a glaze, and it does not actually permeate the glaze.)

Cooling of tiles (step 429) is followed by application 431 of ceramic luster type overglaze or another overglaze of the same type, a mid-firing overglaze which may be applied by means of spraying, thus substantially reducing the labor yet again. After application of the overglaze, the tiles are again prepared and and placed into the kiln (step 433). Previously, it was unknown to apply luster to mosaics/murals, much less to apply it in a straightforward mechanical manner.

Second firing of tiles 435 is at a middle temperature range of roughly cone 020, corresponding to a temperature of roughly 1180 degrees. The times and temperatures of the firing may of course vary within the scope of the invention.

Tiles are allowed to cool a second time, step 437, and the tiles may be buffed 439, labeled to indicate proper placement, and packaged for shipping.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of making a tile mural comprising the steps of:
a) scanning a desired image into a digital device;
b) providing a color printer in operative communication with the digital device, the color printer having ceramic decal print colors and ceramic decal paper for printing onto;
c) directing the color printer to print a first portion of the image onto the ceramic decal paper in multi-tile size using the ceramic decal print colors;
d) laminating the printed sheets;
e) providing multiple blank ceramic tiles having edges;
f) clamping the multiple blank ceramic tiles into a frame;
g) transferring the decal to the multiple ceramic tiles;
h) cutting the decal along the ceramic tile edges;
i) drying the tiles;
j) high firing the tiles;
k) applying ceramic luster to the tiles; and
l) low firing the tiles.

2. The method of claim 1, further comprising:
m) repeating steps c) through l) for a second portion of the image.

3. The method of claim 1, further comprising:
j1) cooling the tiles after high firing.

4. The method of claim 1, further comprising:
l1) cooling the tiles after low firing.

5. The method of claim 1, wherein the step k) further comprises:
applying the luster by spray.

6. The method of claim 1, wherein the step g) further comprises:
soaking the decal to loosen the decal from the backing material prior to transfer.

7. The method of claim 1, further comprising:
g1) squeezing excess air and water from under the decal after transfer.

8. The method of claim 1, wherein the high firing further comprises: high firing the tiles to cone 015.

9. The method of claim 1, wherein the low firing further comprises: low firing the tiles to cone 020.

10. The method of claim 1, further comprising:
a1) editing the image in the digital device.

11. A mural made by the method of claim 1.

12. An improved method of creating a mural, wherein the improvement comprises:
a) printing onto multiple tile sized paper a decal using toners suitable for high firing; and
b) after high firing, spraying on ceramic luster and low firing.
